(19) United States
(12) Patent Application Publication
(10) Pub. No.: US 2024/0087427 A1
(43) Pub. Date: Mar. 14, 2024

(54) SERVER APPARATUS, PURCHASE MANAGEMENT METHOD, INFORMATION PROCESSING SYSTEM, INFORMATION PROCESSING METHOD, AND RECORDING MEDIUM

(71) Applicant: NEC Corporation, Minato-ku, Tokyo (JP)

(72) Inventors: Rumi IKEZAWA, Tokyo (JP); Manabu HIKIN, Tokyo (JP)

(73) Assignee: NEC Corporation, Minato-ku, Tokyo (JP)

(21) Appl. No.: 17/768,093

(22) PCT Filed: Oct. 12, 2020
(86) PCT No.: PCT/JP2020/038436

§ 371 Date: Apr. 11, 2022

(30) Foreign Application Priority Data
Oct. 21, 2019 (JP) 2019-191780

(51) Int. Cl. G07G 1/00; A47F 9/04; G06Q 20/18; G06Q 20/20; G06Q 30/0601

(52) U.S. Cl. CPC G07G 1/0054; A47F 9/047; G06Q 20/18; G06Q 20/208; G06Q 30/0633; G07G 1/0081

(57) ABSTRACT

A server apparatus receives item identification information generated based on an item from a terminal apparatus, and generates a list of items to be purchased based on the received item identification information. Also, when receiving a quantity change request of an item included in the list of items to be purchased, the server apparatus determines whether or not a subject item of the quantity change request is an item prohibited to change a quantity, and transmits information indicating that the quantity is unchangeable to the terminal apparatus when the subject item of the quantity change request is the item prohibited to change the quantity.

### TECHNICAL FIELD

The present disclosure relates to a technical field of a product sales system using a self-checkout register.

### BACKGROUND ART

As a product sales system for a customer who has come to a store to purchase a product, a system is known in which the customer scans a barcode of the product, conducts an item registration, and makes a payment by using a mobile terminal such as a smartphone possessed by the customer. For instance, Patent Document 1 discloses a self-shopping system including a mobile terminal which acquires item information of each of items to be purchased and transmits payment information including all sets of the acquired item information to the management server, and a management server which generates and outputs sorted detail information in which item names are listed in descending order of price based on the item information included in the payment information. Also, Patent Document 2 describes a technique for prohibiting a change in a list of a shopping cart in which items to be purchased are registered.

### PRECEDING TECHNICAL REFERENCES

### Patent Document

Japanese Laid-open Patent Publication No. 2013-41354
Japanese Laid-open Patent Publication No. 2017-157226

### SUMMARY

### Problem to be Solved by the Invention

Some items sold in supermarkets such as meats and side dish are priced according to their net weights. In a system in which a customer scans an item barcode and registers each of items to be purchased, there is a problem that such items can be illegally purchased at lower expense by abusing a quantity change function. For instance, if a barcode of a less expense item with a small amount of net weight is scanned and registered, and then the quantity is increased by a quantity change function with respect to the item with a larger amount of net weight, the item with the large amount of net weight can also be purchased at a price of the item.

An object of the present disclosure is to prevent unauthorized use of a quantity changing function in a purchase management system using a self-checkout register.

### Means for Solving the Problem

In order to solve the above problems, according to an example aspect of the present invention, there is provided a server apparatus including:
an item identification information reception unit configured to receive item identification information generated based on an item, from a terminal apparatus;
a list creation unit configured to create a list of items to be purchased based on the received item identification information;
a quantity change request reception unit configured to receive a quantity change request of an item included in the list of items to be purchased, from the terminal apparatus; and
a determination unit configured to transmit information indicating that a quantity is unchangeable to the terminal apparatus when a subject item of the quantity change request is an item prohibited to change the quantity.

According to still another example aspect of the present invention, there is provided a purchase management method performed by a server apparatus, the purchase management method including:
receiving item identification information generated based on an item, from a terminal apparatus;
creating a list of items to be purchased based on the received item identification information;
receiving a quantity change request of an item included in the list of items to be purchased, from the terminal apparatus; and
transmitting information indicating that a quantity is unchangeable to the terminal apparatus when a subject item of the quantity change request is an item prohibited to change the quantity.

According to a further example aspect of the present invention, there is provided a recording medium storing a program, the program causing a computer to perform a process including:
receiving item identification information generated based on an item, from a terminal apparatus;
creating a list of items to be purchased based on the received item identification information;
receiving a quantity change request of an item included in the list of items to be purchased, from the terminal apparatus; and
transmitting information indicating that a quantity is unchangeable to the terminal apparatus when a subject item of the quantity change request is an item prohibited to change the quantity.

According to an example aspect of the present invention, there is provided an information processing system including:
an acquisition unit configured to acquire item identification information;
a list creation unit configured to create a list of items to be purchased based on the acquired item identification information;
a quantity change unit configured to receive a quantity change request of an item included in the list of items to be purchased; and
a display control unit configured to display information indicating that a quantity is unchangeable on a display unit when a subject item of the quantity change request is an item prohibited to change the quantity.

According to still another example aspect of the present invention, there is provided an information processing method performed by an information processing system including a mobile terminal and a server apparatus, the information processing method including:
acquiring item identification information;
creating a list of items to be purchased based on the acquired item identification information;
receiving a quantity change request of an item included in the list of items to be purchased; and
displaying information indicating that a quantity is unchangeable on a display unit when a subject item of the quantity change request is an item prohibited to change the quantity.

According to a further example aspect of the present invention, there is provided a recording medium storing a program, the program causing a computer to perform a process including:
acquiring item identification information;
creating a list of items to be purchased based on the acquired item identification information;
receiving a quantity change request of an item included in the list of items to be purchased; and
displaying information indicating that a quantity is unchangeable on a display unit when a subject item of the quantity change request is an item prohibited to change the quantity.

### Effect of the Invention

According to the present disclosure, it becomes possible to prevent unauthorized use of a quantity changing function in a purchase management system using a self-checkout register.

### BRIEF DESCRIPTION OF THE DRAWINGS

FIG. 1 illustrates a configuration of a purchase management system according to example embodiments.

FIG. 2 illustrates a schematic configuration of a POS server.

FIG. 3 illustrates a schematic configuration of a management server.

FIG. 4 illustrates a schematic configuration of a mobile terminal.

FIG. 5 illustrates a schematic configuration of a checkout machine.

FIG. 6 is a flowchart of a product purchase process.

FIG. 7 is a flowchart of a store entry process.

FIG. 8 is a flowchart of an item selection process.

FIG. 9 illustrates a display example of an items-to-be-purchased list screen.

FIG. 10 is a flowchart of a checkout process.

FIG. 11 illustrates a display example of a payment screen.

FIG. 12A and FIG. 12B illustrates display examples of a payment method selection screen and a checkout end screen.

FIG. 13 is a flowchart of the item selection process in a case of prohibiting a quantity change for an item prohibited to change a quantity.

FIG. 14 illustrates a display example indicating that a quantity cannot be changed.

FIG. 15 illustrates a display example in a case where a barcode is scanned multiple times for the same items.

FIG. 16 illustrates a configuration of an information processing system according to another example embodiment.

### EXAMPLE EMBODIMENTS

In the following, example embodiments will be described with reference to the accompanying drawings.

[Configuration of a Purchase Management System]

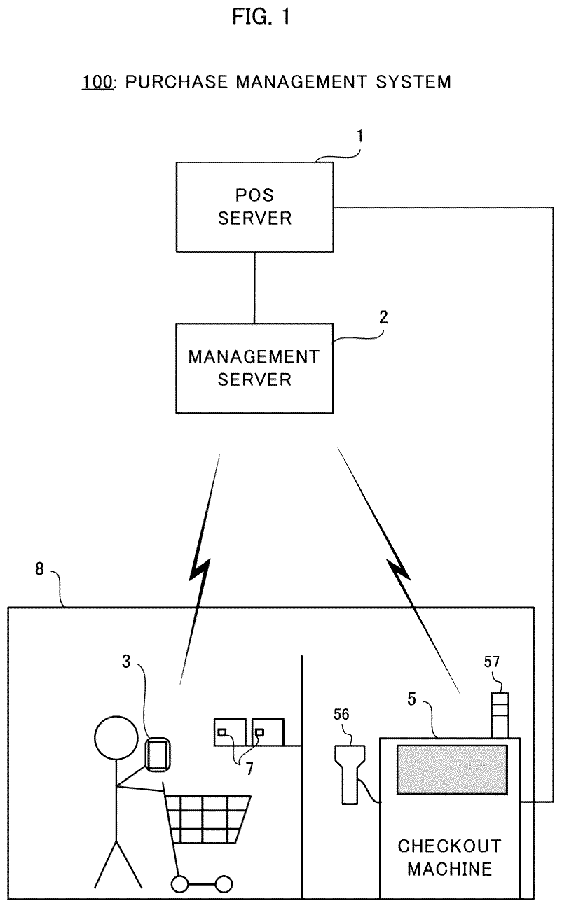

FIG. 1 illustrates a configuration of a purchase management system 100 according to a present example embodiment. The purchase management system 100 mainly includes a POS server 1, a management server 2, a mobile terminal 3, and a checkout machine 5. In the purchase management system 100, a customer using the mobile terminal 3 performs registration of items to be purchased (also referred to as an “items-to-be-purchased”) by scanning an item barcode 7 attached to each item in a store 8 for selling goods, and makes a payment using the checkout machine 5 in the store 8 or by an electronic payment.

The POS server 1 is a server that manages various sales information such as prices concerning goods for sale in the store 8, product information including an inventory status, and the like. The POS server 1 can communicate with the management server 2 and the checkout machine 5 via a network or the like. Incidentally, the POS server 1 may be one that collectively manages sales information of a plurality of affiliated stores, or may be present for each store and manage only the sales information of the store.

Management server 2 is a server apparatus for controlling the mobile terminal 3 and the checkout machine 5, and can communicate with the mobile terminal 3 and the checkout machine 5 via a network or the like. The management server 2 acquires and stores information necessary for display controls of the mobile terminal 3 from the POS server 1. The management server 2 transmits display information to the mobile terminal 3 in order to display various screens on the mobile terminal 3. The above-described various screens include a screen (also referred to as an “items-to-be-purchased list screen”) for displaying, with a selling price, a list of items to be purchased (referred to as an “items-to-be-purchased list”), which are registered by the mobile terminal 3 scanning the item barcode 7.

The management server 2 may be formed by a plurality of server apparatuses. For instance, the management server 2 may include a server apparatus, which mainly performs an interface operation with the mobile terminal 3 such as data exchanges with the mobile terminal 3, and a server apparatus, which stores and manages various information such as information acquired from the POS server 1, the items-to-be-purchased list, and the like. In this case, the former server apparatus functions as a so-called application server, and the latter server apparatus functions as a so-called database server. In this case, these server apparatuses exchange information necessary for each to execute an allocated process via a network or the like.

The mobile terminal 3 is a mobile terminal used by a customer shopping at the shop 8, and includes a function of scanning the item barcode 7 attached to each item, a function of acquiring and displaying various screens such as an items-to-be-purchased list screen by communicating with the management server 2, and the like. Incidentally, in FIG. 1, for convenience of explanation, only one mobile terminal 3 is depicted; however, actually, the mobile terminals 3 for the number of customers entering the store 8 are represented.

The checkout machine 5 is a payment machine (so-called self-checkout machine) for a customer to perform payment using the mobile terminal 3. The checkout machine 5 is capable of communicating with the management server 2, and transmits and receives various information necessary for a payment with the management server 2 and the POS server 1 as necessary. The checkout machine 5 includes a barcode reader 56 for scanning a checkout barcode, which will be described later, from the mobile terminal 3 of the customer, and a light 57 for calling a clerk.

### Configurations of Apparatuses

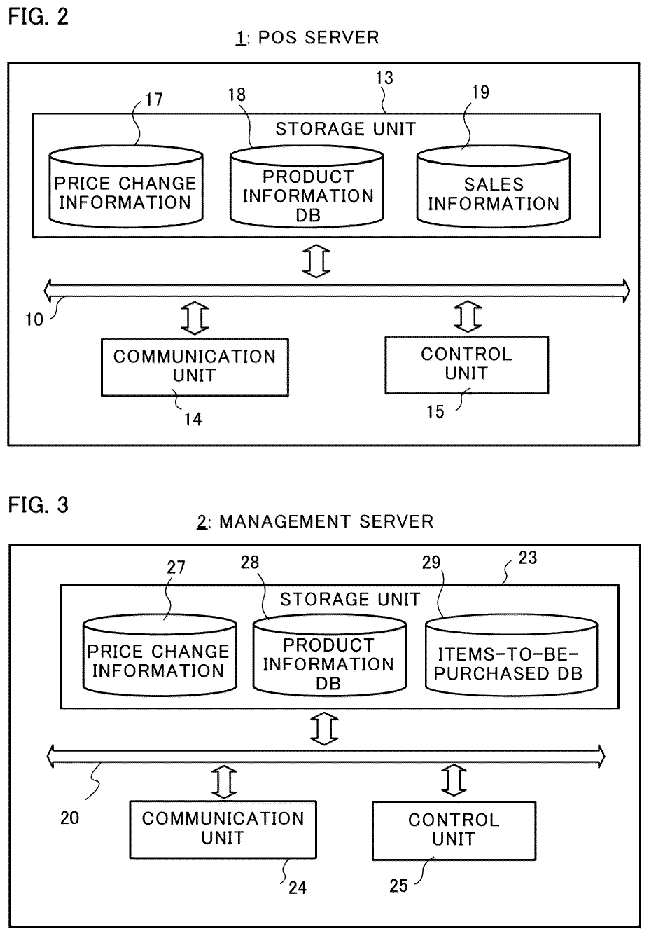

Next, configurations of the POS server 1, the management server 2, the mobile terminal 3, and the checkout machine 5 will be described with reference to FIG. 2 to FIG. 5.

(POS Server)

FIG. 2 illustrates a schematic configuration of the POS server 1. The POS server 1 mainly includes a storage unit 13, a communication unit 14 for performing data communication, and a control unit 15. These elements are mutually connected via a bus line 10.

The storage unit 13 is formed by a memory such as a hard disk or a flash memory. The storage unit 13 stores a program to be executed by the control unit 15, and the information necessary for the control unit 15 to execute a predetermined process by executing a program. In the present example embodiment, the storage unit 13 includes price change information 17, a product information DB (Database) 18, and sales information 19 being information related to sales of goods. Incidentally, the storage unit 13 may store information related to various sales other than the price change information 17, the product information DB 18, and the sales information 19.

The product information DB 18 is a database of information concerning the goods handled by the store 8 or affiliated stores including the store 8. The product information DB 18 includes, for instance, various information such as information (also referred to as “item identification information”) for identifying a product such as a product price and a JAN (Japanese Article Number) code, classification information of a product, an inventory status of the product, and the like.

The price change information 17 is information related to a price change. Specifically, the price change information 17 includes at least one of arbitrary discount information or discount information such as classification specific sales discount information, bundle discount information, set discount information, total discount information, and classification specific price discount information.

The control unit 15 includes a CPU (Central Processing Unit), a ROM (Read Only Memory) and a RAM (Random Access Memory), and the like, which are not illustrated, and performs various controls with respect to each of configuration elements in the POS server 1. For instance, the control unit 15 performs an update or the like of the sales information 19 by communicating with the checkout machine via the communication unit 14. Also, the control unit 15 transmits information related to the price change information 17 and the product information DB 18 to the management server 2 by communicating with the management server 2 via the communication unit 14.

(Management Server)

FIG. 3 illustrates a schematic configuration of the management server 2. The management server 2 mainly includes a storage unit 23, a communication unit 24, and a control unit 25. These elements are mutually connected to each other via a bus line 20.

The storage unit 23 is formed by a memory such as a hard disk or a flash memory. The storage unit 23 stores a program to be executed by the control unit 25, and the information necessary for the control unit 25 to execute a predetermined process by executing a program. In the present example embodiment, the storage unit 23 stores a price change information 27, a product information DB 28, and an items-to-be-purchased list DB 29.

The price change information 27 is information related to a change in the price due to a price discount or a sales discount, similar to the price change information 17. The price change information 27 is periodically or irregularly updated in accordance with controls of the control unit 25, so as to synchronize with the price change information 17 stored in the POS server 1. The product information DB 28 is a database of information concerning goods, similar to the product information DB 18. The product information DB 28 is periodically or irregularly updated to synchronize with the product information DB 18 stored in the POS server 1 in accordance with controls of the control unit 25.

The items-to-be-purchased list DB 29 is a database of items-to-be-purchased lists for each of the mobile terminals 3 of customers who are shopping at stores 8. For instance, the items-to-be-purchased list is regarded as a list which includes item identification information indicating an item to be purchased, and a quantity of the item to be purchased, and is associated with information (referred to as “customer identification information”), which identifies the mobile terminal 3 or the customer using the mobile terminal 3. In addition, the items-to-be-purchased list is updated every time an addition, a deletion, or a quantity change of the items-to-be-purchased occurs based on the operation of the mobile terminal 3.

The communication unit 24 communicates with the POS server 1, the mobile terminal 3, and the checkout machine 5 through wired or wireless communications. The control unit 25 includes a CPU, a ROM and a RAM, and the like, which are not illustrated, and performs various controls with respect to each of configuration elements in the management server 2. Processes executed by the control unit 25 will be described later. In the above configuration, the communication unit 24 corresponds to examples of an item identification information acquisition unit and a quantity change request reception unit, and the control unit 25 corresponds to examples of a list creation unit and a determination unit.

(Mobile Terminal)

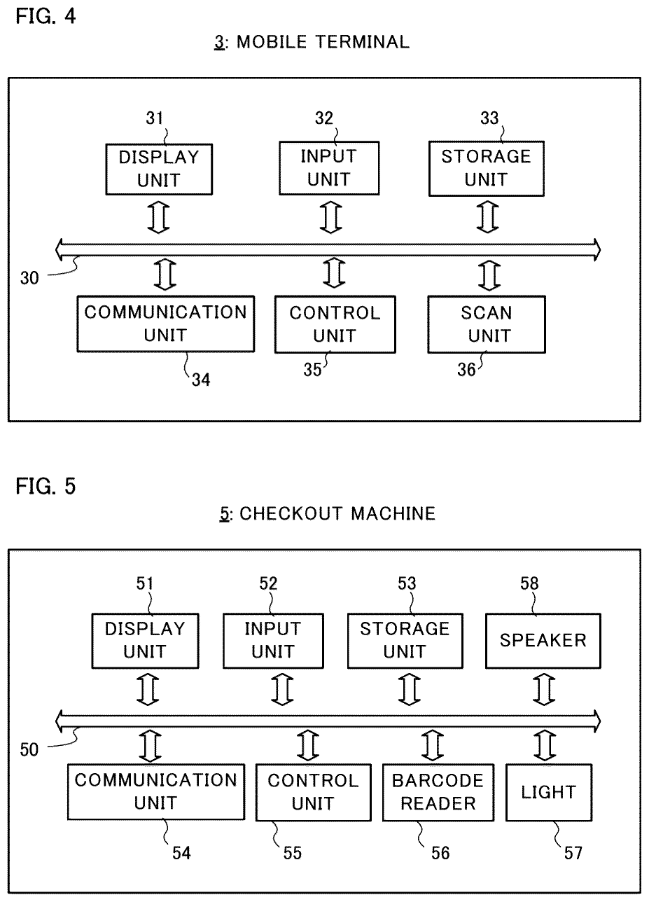

FIG. 4 illustrates a schematic configuration of the mobile terminal 3. The mobile terminal 3 mainly includes a display unit 31, an input unit 32, a storage unit 33, a communication unit 34, a control unit 35, and a scan unit 36. These elements are mutually connected to each other via a bus line 30.

The display unit 31 displays various information such as an items-to-be-purchased list, a checkout barcode, or the like in accordance with controls of the control unit 35. The input unit 32 is an interface to accept an input from a user, and corresponds to, for instance, a touch panel, a button, a voice input device, or the like.

The storage unit 33 is formed by a memory such as a hard disk or a flash memory. The storage unit 33 stores a program to be executed by the control unit 35, and information necessary for the control unit 35 to perform a predetermined process by executing a program. For instance, the storage unit 33 stores a dedicated application program, which is started when shopping is performed at the shop 8 and which controls a display of various screens such as an items-to-be-purchased list screen and the like.

The communication unit 34 communicates with the management server 2 through wireless communications. The control unit 35 includes a CPU, a ROM and a RAM, and the like, which are not illustrated, and performs various controls for each of configuration elements in the mobile terminal 3. Controls conducted by the control unit 35 will be described later.

The scan unit 36 is, for instance, an optical device such as a camera, scans the item barcode 7 attached to each item, and supplies the scanned information to the control unit 35. In the present example embodiment, the control unit 35 acquires item identification information such as the JAN code from the item barcode 7 attached to each item based on information output by the scan unit 36.

(Checkout Machine)

FIG. 5 illustrates a schematic configuration of the checkout machine 5. The checkout machine 5 mainly includes a display unit 51, an input unit 52, a storage unit 53, a communication unit 54, a control unit 55, a barcode reader 56, a light 57, and a speaker 58. These elements are mutually connected to each other via a bus line 50.

The display unit 51 performs a display of various information such as a payment method selection screen and an end screen based on controls of the control unit 55. The input unit 52 is an interface, which accepts an input from a customer and corresponds to, for instance, a touch panel, a button, or the like.

The storage unit 53 is formed by a memory such as a hard disk or a flash memory. The storage unit 53 stores a program to be executed by the control unit 55, and information necessary for the control unit 55 to conduct a predetermined process by executing a program. For instance, the storage unit 53 stores a dedicated application program for performing a checkout process when the customer makes a payment.

The control unit 55 includes a CPU, a ROM and a RAM, and the like, which are not illustrated, and performs various controls for each of configuration elements in the checkout machine 5. Controls performed by the control unit 55 will be described later. The barcode reader 56 scans the checkout barcode displayed on the mobile terminal 3 of the customer when the customer makes a payment, and supplies the scan information to the control unit 55. The light 57 is turned on in a case where a problem occurs in the checkout machine 5, in a case of calling a clerk, or the like. The speaker 58 outputs an operation sound or a voice message for attention as necessary.

[Product Purchase Process]

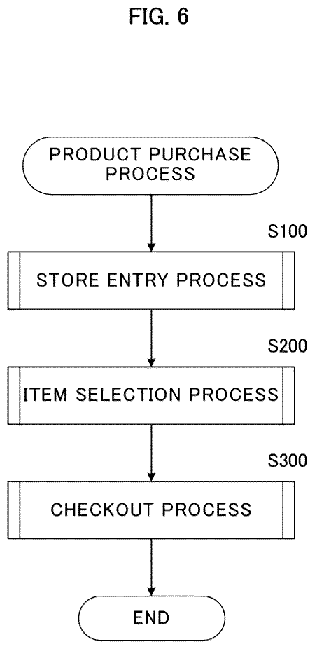

Next, an outline of a product purchase process by the purchase management system 100 will be described. The product purchase process is a process in which a customer purchases a product using the mobile terminal 3 in the store 8. FIG. 6 is a flowchart illustrating an outline of the product purchase process. The product purchase process is roughly divided into a store entry process S100, an item selection process S200, and a checkout process S300. Note that the product purchase process is realized by mainly the management server 2, the mobile terminal 3 and the checkout machine 5 executing respective programs prepared in advance.

(Store Entry Process)

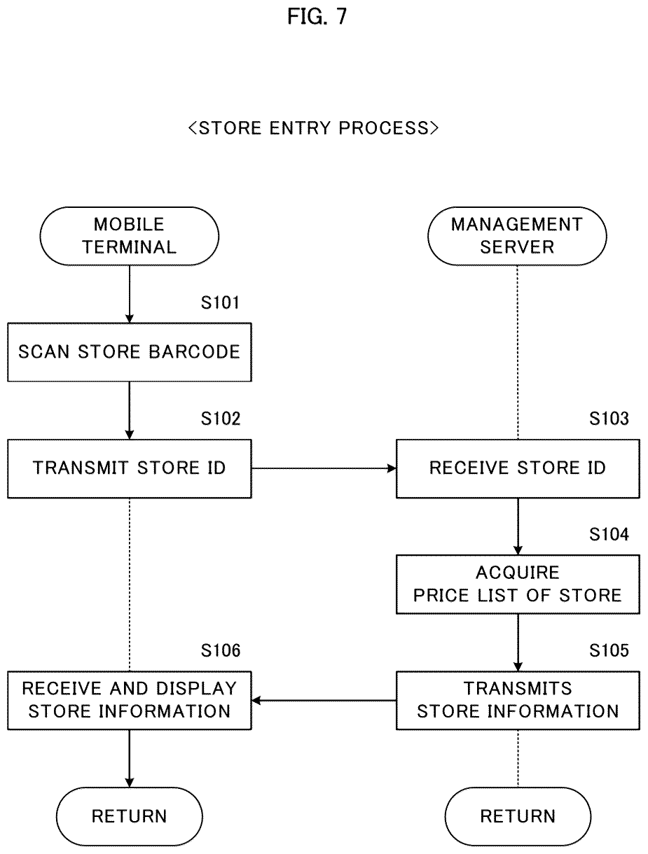

First, a store entry process will be described. The store entry process is a process, which is performed prior to a purchase of a product, when a customer enters the store 8, which corresponds to preparation for the purchase of the product. FIG. 7 is a flowchart illustrating an example of the store entry process. The store entry process is performed by the mobile terminal 3 and the management server 2.

First, when the customer enters the store 8, the customer scans a store barcode using the mobile terminal 3 (step S101). The store barcode is attached at a predetermined location in the store 8, for instance, a wall near an entrance of the store or a card used for shopping. When the customer scans the store barcode, the mobile terminal 3 acquires the store ID from the scanned store barcode and transmits the store ID to the management server (step S102). In a case of transmitting a store ID, the mobile terminal 3 transmits the customer identification information, which identifies the mobile terminal 3 or the customer using the mobile terminal 3, together with the store ID. Noted that even in the item selection process and the checkout process described below, when the mobile terminal 3 basically also transmits some information to the management server 2, the mobile terminal 3 transmits the customer identification information for identifying itself with the information.

The management server 2 receives the store ID from the mobile terminal 3 (step S103) and acquires a price list of the store from the product information DB 28 (step S104). This is because prices of goods differ for each store. After that, the management server 2 transmits store information including a store name and sale information of the store to the mobile terminal 3 (step S105), and the mobile terminal 3 receives the store information (step S106). By this store entry process, a current store name, the sale information of the store, and the like are displayed on the display unit 31 of the mobile terminal 3, and the customer can start shopping. The store information, which the management server 2 sends, includes information indicating a transaction status of the customer in the store, and the transaction status becomes new when a new shopping is started at the store. On the other hand, in a case where the customer has interrupted shopping at the store for some reason, an items-to-be-purchased list screen corresponding to the transaction status up to that point is displayed on the mobile terminal 3.

(Item Selection Process)

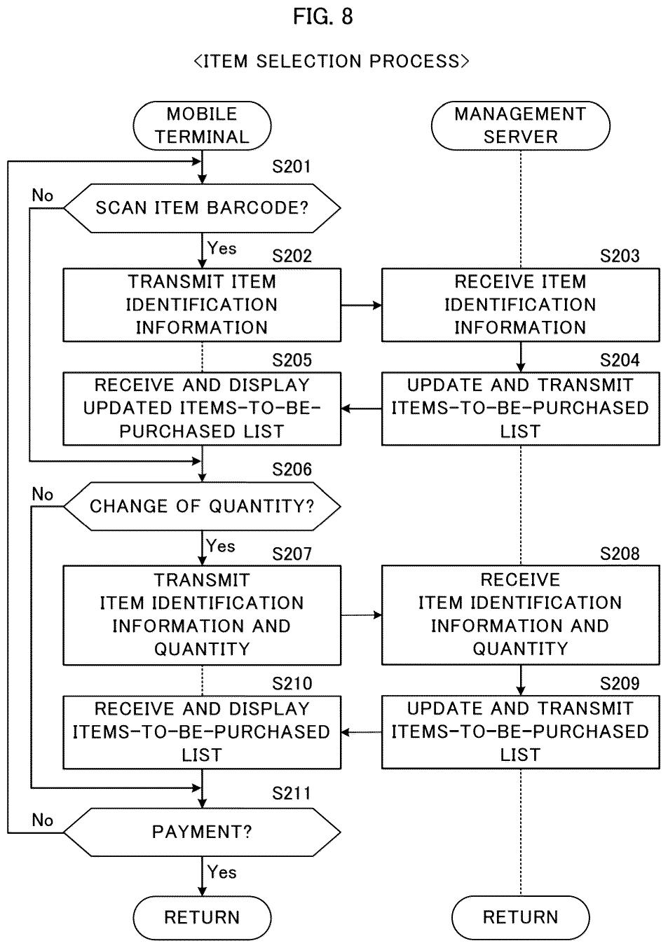

Next, an item selection process will be described. The item selection process is a process in which the customer scans the item barcode 7 attached to each item using the mobile terminal 3 and registers item information in the items-to-be-purchased list. FIG. 8 is a flowchart of the item selection process. This process is executed by the mobile terminal 3 and the management server 2.

First, when a customer finds an item desired to purchase, the customer sets the mobile terminal 3 to an item scan mode, and scans the item barcode 7 attached to the item by the mobile terminal 3 (step S201: Yes). The mobile terminal 3 transmits item identification information of the scanned item to the management server 2 (step S202). At this time, a quantity of the item is automatically set to “1”. When receiving the item identification information from the mobile terminal 3 (step S203), the management server 2 updates and transmits the items-to-be-purchased list to the mobile terminal 3 (step S204). The mobile terminal 3 receives and displays the updated items-to-be-purchased list on the display unit 31 (step S205). Accordingly, newly added items and respective quantities are additionally recorded to the items-to-be-purchased list and displayed on the mobile terminal 3.

Next, when the customer operates the mobile terminal 3 to change a quantity of the item as needed, the mobile terminal 3 acquires the changed quantities (S206 of steps: Yes). When an item barcode is first scanned, the quantity of that product is automatically set to be “1”; however, in a case where a customer purchases multiple same items, the quantity can be changed upon operating the mobile terminal 3. When the changed quantity is set, the mobile terminal 3 transmits the item identification information of the item of which quantity is changed and the changed quantity to the management server 2 (step S207).

When receiving the item identification information and the changed quantity from the mobile terminal 3 (step S208), the management server 2 updates the items-to-be-purchased list and transmits the items-to-be-purchased list to the mobile terminal 3 (step S209). The mobile terminal 3 receives the updated items-to-be-purchased list and displays the updated items-to-be-purchased list on the display unit 31 (S210 of steps). Accordingly, the change in quantity is reflected in the items-to-be-purchased list.

Next, the mobile terminal 3 determines whether a payment button 45 is pressed by the customer (step S211). The payment button 45 is a button to be pushed when the customer finishes shopping. When the payment button 45 is not pressed (step S211: No), the item selection process returns to step 201. Accordingly, until the payment button 45 is pressed, the customer can add an item or change the quantity, and continue shopping. After that, when the payment button is pressed (step S211: Yes), the item selection process is terminated.

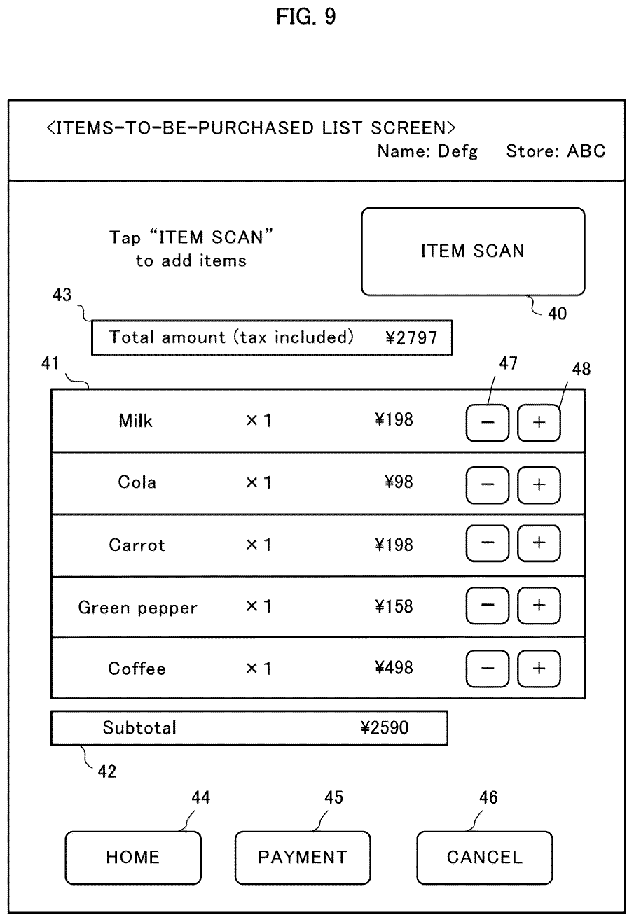

FIG. 9 illustrates a display example of the items-to-be-purchased list screen displayed on the mobile terminal 3. In this example, the items-to-be-purchased list screen includes an item scan button 40, a list display column 41, a subtotal display column 42, a total amount display column 43, a home screen transition button 44, the payment button 45, and a transaction cancel button 46.

When detecting that the item scan button 40 is selected by a tap operation or the like, the mobile terminal 3 switches a display of the display unit 31 to the item scan screen. In the item scan screen, the mobile terminal 3 displays an image or the like acquired from the started scan unit 36. Accordingly, the customer moves the item or the mobile terminal 3 so that the item barcode 7 is positioned within a scan range of the scan unit 36, and scans the item barcode 7.

For each of the items-to-be-purchased, a name, a quantity, and a price of the items-to-be-purchased are displayed in the list display column 41. Also, for each of the items-to-be-purchased in the list display column 41, a quantity decrease button 47, and a quantity increase button 48 are displayed. After that, in a case where the mobile terminal 3 receives a quantity change for the items-to-be-purchased by an operation of the quantity decrease button 47 or the quantity increase button 48, and the mobile terminal 3 transmits the item identification information of the items-to-be-purchased for which a quantity has been changed, and the changed quantity to the management server 2.

The subtotal display column 42 displays a subtotal amount without tax with respect to selling prices for all items in the items-to-be-purchased list, and the total amount display column 43 displays a total amount including tax with respect to the selling prices for all items in the items-to-be-purchased list. The management server 2 calculates the subtotal amount or the total amount based on prices of items-to-be-purchased registered in the product information DB 28, specifically, a selling price list of the store acquired by the store entry process.

When detecting that the home screen transition button 44 is selected, the mobile terminal 3 transmits a display request of a home screen to the management server 2 and displays a predetermined home screen based on display information received as a response. The home screen may be one that displays a discount and discount information at the store 8, registration information of a customer of the mobile terminal 3, and the like.

When detecting that the payment button 45 is selected, the mobile terminal 3 transmits a checkout request to the management server 2, and displays a payment screen including a checkout barcode, which will be described later, based on the display information to receive as a response. Also, when detecting that the transaction cancel button 46 has been selected, the mobile terminal 3 transmits information to report a transaction cancel to the management server 2. In this case, the management server 2 deletes the items-to-be-purchased list corresponding to the mobile terminal 3.

(Checkout Process)

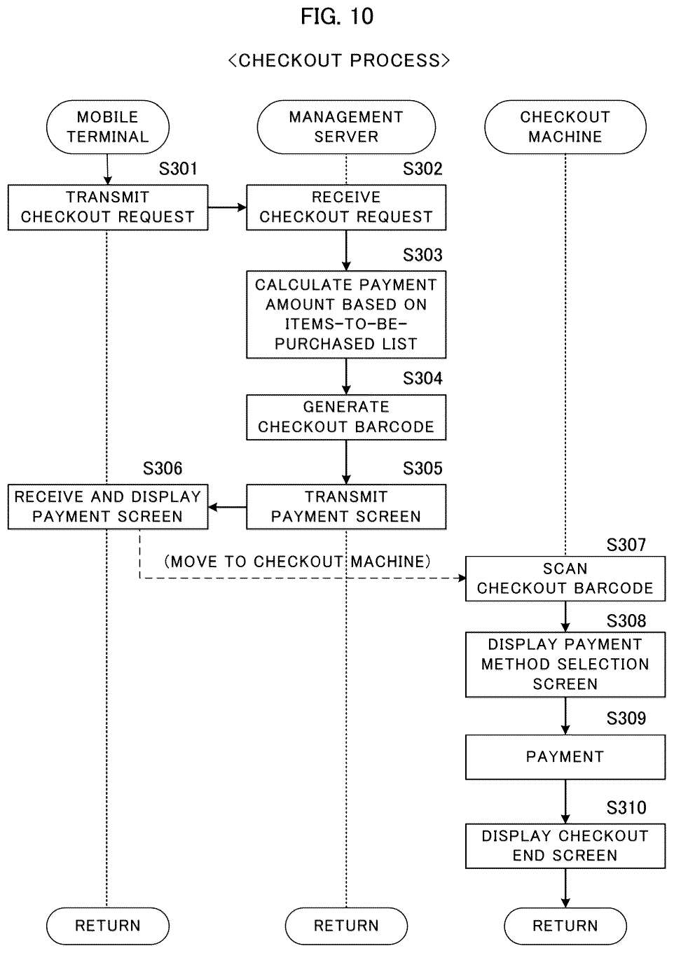

Next, a checkout process will be described. The checkout process is a process for paying items selected by the customer through the item selection process. FIG. 10 is a flowchart of the checkout process. This checkout process is executed by the mobile terminal 3, the management server 2, and the checkout machine 5.

First, when the payment button 45 described above is pressed, the mobile terminal 3 transmits a checkout request to the management server 2 (step S301). When receiving the checkout request (step S302), the management server 2 calculates a payment amount based on the items-to-be-purchased list at that time (step S303). Moreover, the management server 2 generates a checkout barcode (step S304). The checkout barcode corresponds to information for uniquely identify purchase contents indicated by a current items-to-be-purchased. As one example, the checkout barcode can be a random code uniquely corresponded to a purchase content at that time. In this case, the checkout barcode has a meaning as an inquiry number for payment information. The management server 2 transmits a payment screen concluding the payment amount calculated in step S303 and the checkout barcode generated in step S304 to mobile terminal 3 (step S305).

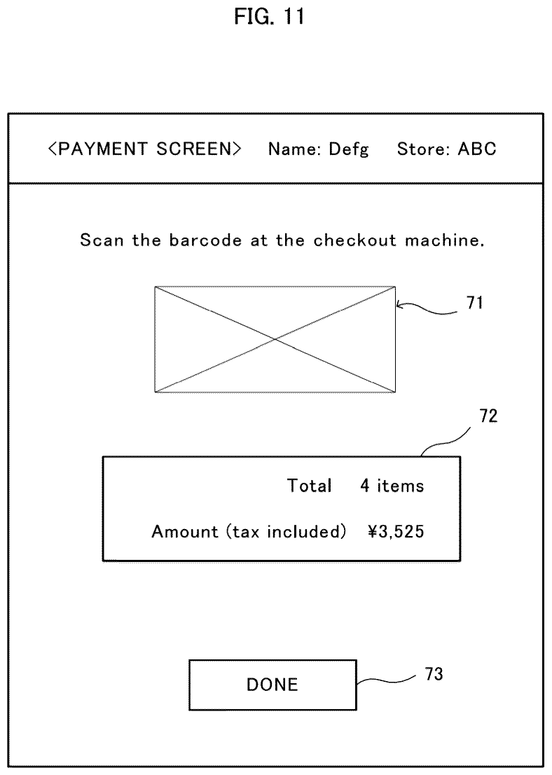

The mobile terminal 3 displays the received payment screen on the display unit 31 (step S306). FIG. 11 is a display example of the payment screen. In this example, the payment screen includes a checkout barcode 71, a total amount column 72, and a done button 73. The customer moves to the checkout machine 5 with the mobile terminal 3 on which the payment screen is displayed, and scans the checkout barcode by the barcode reader 56 (step S307). The checkout machine 5 displays the payment method selection screen based on the scanned checkout barcode (step S308). Specifically, the checkout machine 5 transmits the inquiry number indicated by the checkout barcode to the management server 2, and acquires the payment information from the management server 2. Incidentally, the payment information includes the total amount, and details such as IDs and quantities of all items indicated in the items-to-be-purchased list. The checkout machine 5 displays the payment method selection screen based on the acquired payment information.

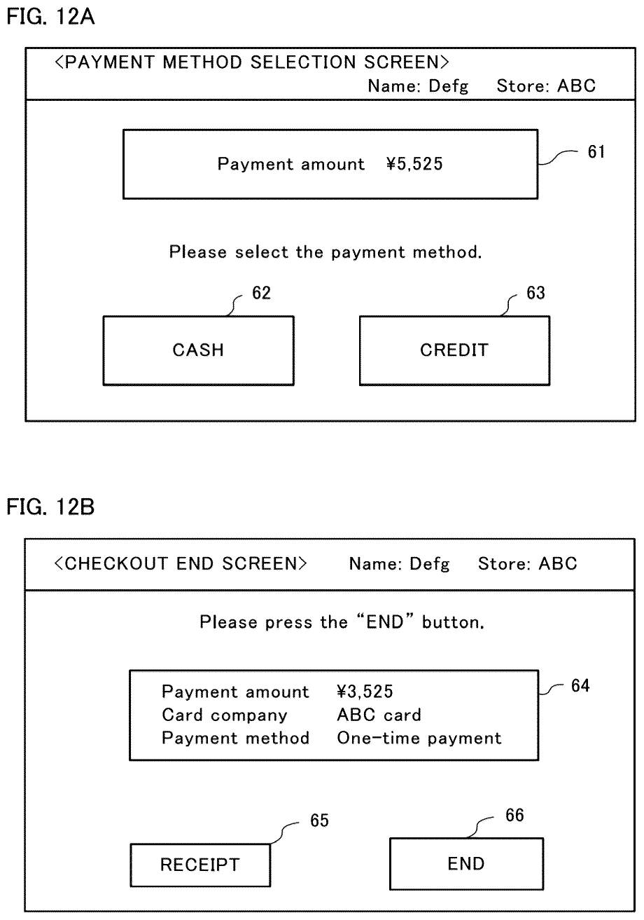

FIG. 12A illustrates a display example of the payment method selection screen. The payment method selection screen includes a total amount column 61, a cash button 62, and a credit button 63. The customer confirms a payment amount by looking at the payment method selection screen, and presses either the cash button 62 or the credit button 63 to make the payment. By this operation, the payment is made for a purchase of items (step S309). Specifically, in a case where the customer selects to make a payment in cash, the checkout machine 5 prompts the cash to be put into a cash slot, and when the cash is put in, change is returned if needed. In a case where the customer selects to pay by credit, the checkout machine 5 prompts to insert a card, prompts to input a personal identification number or the like as necessary, and makes a credit payment.

When the payment is completed, the checkout machine 5 displays a checkout end screen (step S310). FIG. 12B illustrates a display example of the checkout end screen. FIG. 12B illustrates a case example in which a customer selects a credit payment, and the checkout end screen includes a payment information column 64, a receipt button 65, and an end button 66. The payment information column 64 displays information such as a payment amount, a payment method, and the like. The receipt button 65 is a button for printing out the receipt. The end button 66 is a button for confirming that the customer has completed the checkout process. When the customer presses the end button 66, the checkout machine 5 reports that the payment has been completed to the management server 2, and returns the display of the display unit 51 to a main menu. Incidentally, as illustrated in FIG. 11, the done button 73 is also displayed on the payment screen displayed on the mobile terminal 3, the customer presses the done button 73 on the payment screen when the checkout process is completed. When the done button 73 is pressed, the mobile terminal 3 reports that the payment has been completed to the management server 2, and returns the display unit 31 to the main menu.

In the above example, the checkout barcode is merely the inquiry number of the payment information, and the checkout machine 5 obtains the payment information from the management server 2 using the inquiry number.

Alternatively, the checkout barcode may include payment information. That is, when receiving a checkout request, the management server 2 generates a checkout barcode using information of the total amount and the items-to-be-purchased list based on contents of the items-to-be-purchased list at that time. In this case, since by scanning and decoding the checkout barcode, the checkout machine 5 can acquire the payment information, there is no need to communicate with the management server 2 to obtain the payment information. That is, the checkout machine 5 may extract a total amount from the scanned checkout barcode, and display the payment method selection screen.

[Prohibition of Quantity Change]

Next, a prohibition of changing a quantity according to the present example embodiment will be described. As described above, the quantity can be changed in the item selection process. That is, in a case of purchasing multiple same items, the customer scans the item barcode 7 from one item and increases the quantity of the item, so as to be unnecessary to scan the barcode 7 multiple times for the same items. However, for a specific type of an item, by exploiting this quantity change function, the item can be purchased at a lower price than a real price.

Concretely, it is possible to exploit the quantity change function for types of items which prices are determined depending on a net weight, such as meat and side dish (called “items sold by weight”). For instance, in a case of scanning a barcode attached to a package of meat which is the lowest net weight and the cheapest price, of incrementing one to the quantity of the meat package, and of carrying out a payment for the package scanned by the barcode and another package of heavier meat in net weight, it may be possible to purchase a second package of meat with the same price as that of a first package of meat. In addition, in a case of items other than sold by net weight, it may be possible to exploit the quantity change function with respect to items with discounted prices according to states of the items (referred to as “discounted items according to respective states”). For instance, there are products that are the same, but are discounted because a package of an item is damaged or an expiration date is approaching. In this case, generally, the more painful the item becomes cheaper, and the closer the expiration date, the cheaper the price of the item is. In such the case of purchasing multiple items, if a barcode of the least expensive item is scanned and a quantity of the item is increased by the quantity change function, the second and subsequent items can be purchased at the same price as that of the first item.

Accordingly, in the present example embodiment, the quantity change is prohibited with regard to the aforementioned specific items (hereinafter, referred to as “items prohibited to change quantities”). Specifically, the items prohibited to change quantities are identified based on item identification information and the quantity change is disallowed with respect to the items prohibited to change quantities. In one method, specific codes are given to the product bar codes given to the products for which the quantity change is prohibited. In another method, in the product information DB 18 of the POS server 1 or the product information DB 28 of the management server 2, the item identification information of the item prohibited to change the quantity and information indicating (that is, a flag) that the quantity is disallowed to be changed are stored in association with each other. By this restriction of the quantity change, it is possible for the management server 2 to determine whether an item is one prohibited to change the quantity based on the item identification information received from the mobile terminal 3.

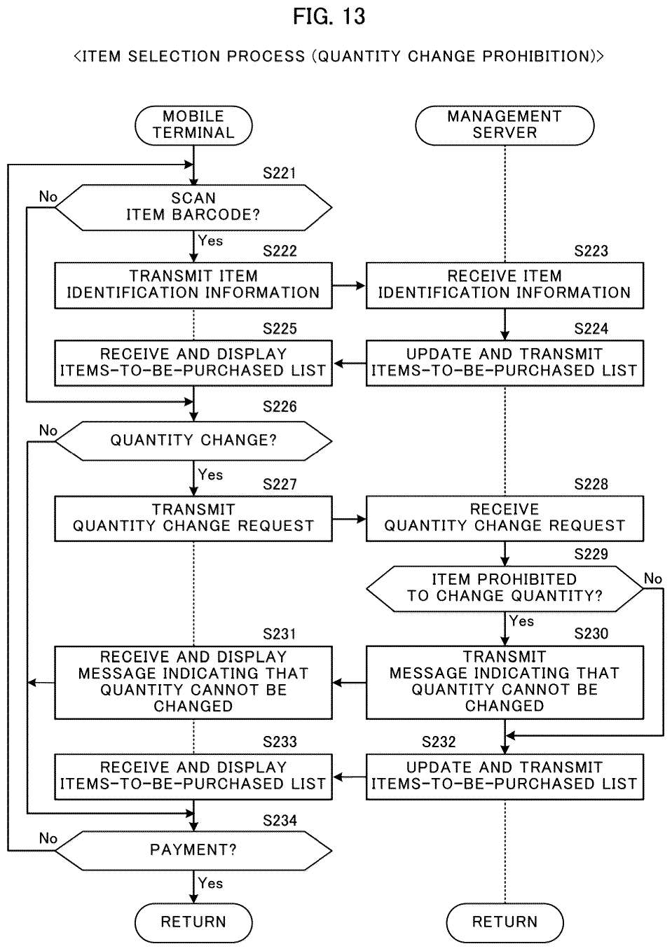

FIG. 13 is a flowchart of the item selection process in a case of prohibiting the quantity change of an item prohibited to change the quantity. The item selection process in FIG. 13 is basically based on the item selection process depicted in FIG. 8, and since steps S221 through S225 are the same as steps S201 through S205 in FIG. 8, explanations thereof will be omitted.

At the mobile terminal 3, when a customer specifies a target item and instructs to change a quantity of the target item (step S226: Yes), the mobile terminal 3 transmits a quantity change request including item identification information of the item and a changed quantity to the management server 2 (step S227). Incidentally, the customer instructs to change the quantity, for example, on the items-to-be-purchased list screen illustrated in FIG. 9, by pressing the quantity increase button 48. When receiving the quantity change request (step S228), the management server 2 determines whether or not the target item indicated by the item identification information is the item prohibited to change the quantity (step S229). This determination is made by the management server 2 checking whether or not the item identification information is associated with information indicating that the specific code is included or information indicating that the quantity change is prohibited in the product information DB.

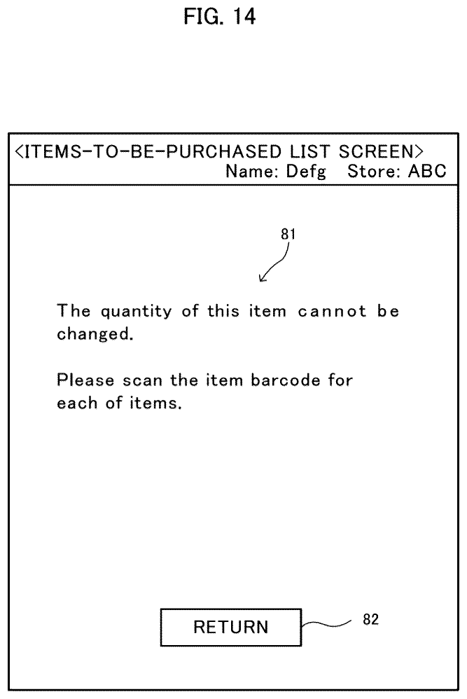

When the target item of the quantity change is the item prohibited to change the quantity (step S229: Yes), the management server 2 sends a message indicating that the quantity cannot be changed, to the mobile terminal 3 (step S230). The mobile terminal 3 receives and displays the message (step S231). FIG. 14 illustrates a display example of the message indicating that the quantity cannot be changed. A message 81 explains that the item is one which quantity cannot be changed, and requests to scan the item barcode for each of items. Note that, when the customer presses a return button 82 on the screen in FIG. 14, the display of mobile terminal 3 returns to the items-to-be-purchased list screen depicted in FIG. 9.

On the other hand, when the target item of the quantity change is not the item prohibited to change the quantity (step S229: No), the management server 2 updates the items-to-be-purchased list based on the quantity change request, and transmits the updated items-to-be-purchased list to the mobile terminal 3 (step S232). The mobile terminal 3 receives and displays the updated items-to-be-purchased list on the display unit 31 (step S233) Accordingly, the changed quantity is applied to the items-to-be-purchased list.

Next, the mobile terminal 3 determines whether or not the payment button is pressed by the customer (step S234). When the payout button 45 is not pressed (step S234: No), the item selection process returns to step 221. On the other hand, when the payment button 45 is pressed (step S234: Yes), the item selection process is terminated. Accordingly, by prohibiting the quantity changes for items sold by net weight and items discounted according to respective states, it is possible to prevent the misuse of the quantity changes.

Due to the item selection process described above, it is possible to prevent exploiting the quantity change function and illegally purchasing items by a lower cost. However, in a case where the customer does not use the quantity change function and scans an item barcode multiple times for the same items prohibited to change quantities, the same items may be purchased by an illegally lower cost. For instance, in the example of the package of meat described above, in a case where a customer scans a barcode twice for one package of the lowest expense, holding and making a payment for the one package and another package of which net weight is heavier than the one package, it may be possible to purchase a second package of meat with the same price as that of a first package.

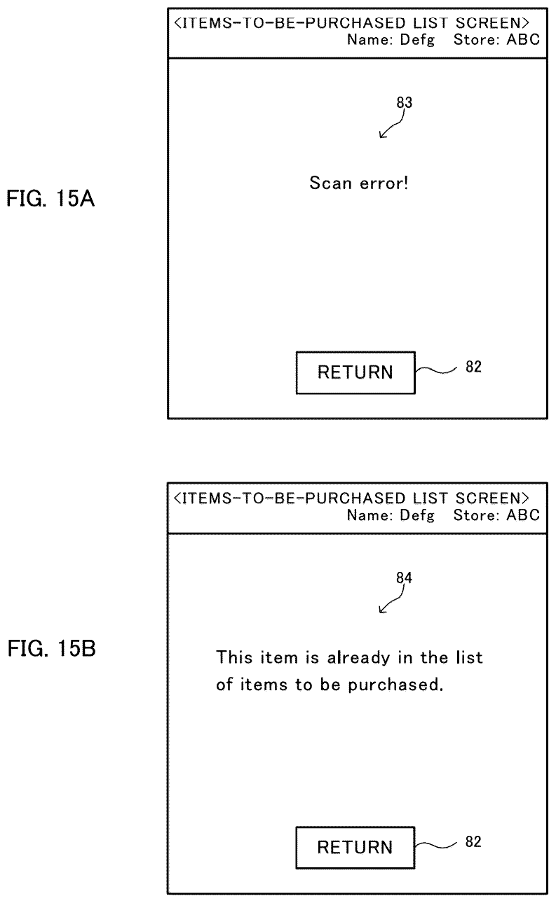

In order to prevent this manner, in a case where the item barcodes of the same quantity change prohibited goods are read multiple times, the management server 2 may error the second and subsequent readings. Since respective prices of items prohibited to change quantities are different, the item identification information indicated by the barcode attached to each item is also different. As in the above example, in a case where the customer scans an item barcode twice from a package of the cheapest meat, at a time of a second scan, the same item prohibited to change the quantity already exist in the items-to-be-purchased list. Hence, in a case where the same item prohibited to change the quantity is scanned multiple times, the management server 2 may invalids the scanned information. Specifically, the management server 2 displays a message 83 indicating a “scan error” on the mobile terminal 3 as depicted in FIG. 15A or displays a message indicating that the item is already indicated in the items-to-be-purchased list on the mobile terminal 3 as depicted in FIG. 15B, so as to inform the customer that the second and subsequent scans are invalid. Therefore, even in a case of scanning one item barcode multiple times with respect to a plurality of the same items prohibited to change the quantities rather than using the quantity change function, it is possible to prevent items prohibited to change the quantities from being illegally purchased at a lower price.

### Other Example Embodiments

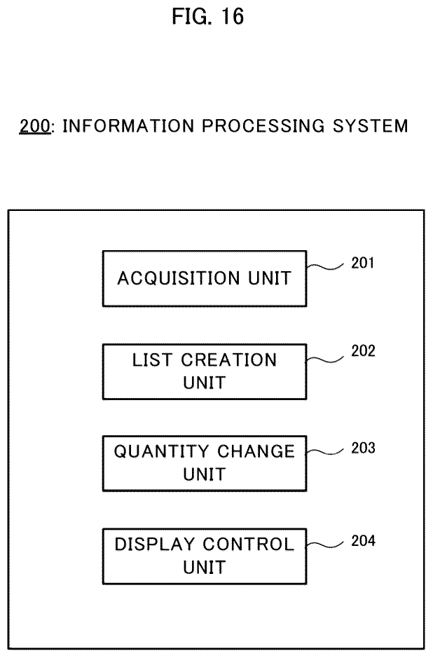

FIG. 16 illustrates a configuration of an information processing system according to another example embodiment. An information processing system 200 prohibits a quantity change with respect to items prohibited to change quantities, similar to the above-described example embodiment. As a hardware configuration, the information processing system 200 includes the management server 2 and the mobile terminal 3 depicted in FIG. 1.

Also, as illustrated in FIG. 16, the information processing system 200 includes an acquisition unit 201, a list creation unit 202, a quantity change unit 203, and a display control unit 204 as a functional configuration. The acquisition unit 201 acquires item identification information based on an operation by a customer at the mobile terminal 3. The list creation unit 202 creates an items-to-be-purchased list based on the item identification information acquired by the acquisition unit 201. The quantity change unit 203 receives a quantity change request for in item indicated in the items-to-be-purchased list based on an operation by the customer at the mobile terminal 3. Then, in a case where a target item of the quantity change request is an item prohibited to change the quantity, the display control unit 204 displays information indicating that the quantity cannot be changed on the display unit of the mobile terminal. Hence, in a case where the customer makes the quantity change request for item prohibited to change the quantity, it is possible to display on the display unit of the mobile terminal that the quantity is unchangeable.

### Modification

### Modification 1

In the above example embodiment, a quantity is restricted with respect to the items prohibited to change the quantity when the customer instructs the quantity change by pressing the quantity increase button 48 depicted in FIG. 9; however, the application of the present disclosure is not limited thereto. For instance, in a case where a customer can operate a quantity display column of each item in the items-to-be-purchased list screen, the above-described quantity change prohibition process may be performed in response to an instruction of the quantity change by the customer operating the quantity display column. In addition, in a case where an instruction of the quantity change can be made on the item scan screen for scanning an item barcode, the above-described quantity change prohibition process may be performed for the instruction of the quantity change entered on the item scan screen.

### Modification 2

In the above-described example embodiment, a barcode applied to a product is scanned by the mobile terminal 3; however, instead, a QR (Quick Response) code may be applied to the product and the QR code may be scanned by the mobile terminal 3.

### Modification 3

In the above-described example embodiment, a system is used in which a customer registers an item in a items-to-be-purchased list by scanning the item barcode in the mobile terminal 3. Instead, a system may be used to specify individual items by capturing images of the items and to register the items in the items-to-be-purchased list. In this case, an item scan apparatus, which registers an item to purchase in the items-to-be-purchased list, captures an item placed at a predetermined position by a camera or the like, identifies the item by an image recognition from the captured image, generates item identification information indicating the item, and transmits the item identification information to the management server 2. Similar to the above-described example embodiment, the management server 2 may generate the items-to-be-purchased list based on the item identification information transmitted from the item scan apparatus, and perform a checkout process or the like. Even in this case, the management server 2 and the above-described quantity change prohibition process in the item selection process, it is possible to execute a process for invalidating multiple scans with respect to the same items prohibited to change the quantities.

In addition, part or all of each of the example embodiments described above (including modifications, the same below) may also be described as the following supplementary notes, but not limited thereto.

### Supplementary note 1

1. A server apparatus comprising:
an item identification information reception unit configured to receive item identification information generated based on an item, from a terminal apparatus;
a list creation unit configured to create a list of items to be purchased based on the received item identification information;
a quantity change request reception unit configured to receive a quantity change request of an item included in the list of items to be purchased, from the terminal apparatus; and
a determination unit configured to transmit information indicating that a quantity is unchangeable to the terminal apparatus when a subject item of the quantity change request is an item prohibited to change the quantity.

(Supplementary Note 2)

2. The server apparatus according to supplementary note 1, wherein
the item identification information of the item prohibited to change the quantity includes a specific information, and
the determination unit determines whether or not the item corresponds to the item prohibited to change the quality based on whether or not the specific information is included in the item identification information of the subject item of the quantity change request.

(Supplementary Note 3)

3. The server apparatus according to supplementary note 1, further comprising a database configured to store items prohibited to change quantities in association with corresponding item identification information,
wherein the determination unit determines, by referring to the database, whether or not the subject item of the quantity change request is one of the items prohibited to change the quantities.

(Supplementary Note 4)

4. The server apparatus according to any one of supplementary notes 1 through 3, wherein when the item identification information reception unit receives the item identification information of the same item prohibited to change the quantity multiple times, the determination unit transmits information indicating an error to the terminal apparatus.

(Supplementary Note 5)

5. The server apparatus according to any one of supplementary notes 1 through 3, wherein when the item identification information reception unit receives the item identification information of the same item prohibited to change quantity, the determination unit transmits information indicating that the item has been already included in the list of items to be purchased.

(Supplementary Note 6)

6. The server apparatus according to any one of supplementary notes 1 through 4, wherein the terminal apparatus is a mobile terminal, and the item identification information is information scanned by the mobile terminal from a code applied to each item.

(Supplementary Note 7)

7. The server apparatus according to any one of supplementary notes 1 through 4, wherein the terminal apparatus is an apparatus that captures an image of the item, and generates the item identification information based on the captured image.

(Supplementary Note 8)

8. The server apparatus according to any one of supplementary notes 1 through 7, wherein the item prohibited to change quantity corresponds to one of items sold by weight and a discounted item according to a state.

(Supplementary Note 9)

9. A purchase management method performed by a server apparatus, the purchase management method comprising:
receiving item identification information generated based on an item, from a terminal apparatus;
creating a list of items to be purchased based on the received item identification information;
receiving a quantity change request of an item included in the list of items to be purchased, from the terminal apparatus; and
transmitting information indicating that a quantity is unchangeable to the terminal apparatus when a subject item of the quantity change request is an item prohibited to change the quantity.

(Supplementary Note 10)

10. A recording medium storing a program, the program causing a computer to perform a process comprising:
receiving item identification information generated based on an item, from a terminal apparatus;
creating a list of items to be purchased based on the received item identification information;
receiving a quantity change request of an item included in the list of items to be purchased, from the terminal apparatus; and
transmitting information indicating that a quantity is unchangeable to the terminal apparatus when a subject item of the quantity change request is an item prohibited to change the quantity.

(Supplementary Note 11)

11. An information processing system including a terminal apparatus and a server apparatus, the information processing system comprising:
an acquisition unit configured to acquire item identification information;
a list creation unit configured to create a list of items to be purchased based on the acquired item identification information;
a quantity change unit configured to receive a quantity change request of an item included in the list of items to be purchased; and
a display control unit configured to display information indicating that a quantity is unchangeable on a display unit when a subject item of the quantity change request is an item prohibited to change the quantity.

(Supplementary Note 12)

12. An information processing method performed by an information processing system including a mobile terminal and a server apparatus, the information processing method comprising:
acquiring item identification information;
creating a list of items to be purchased based on the acquired item identification information;
receiving a quantity change request of an item included in the list of items to be purchased; and
displaying information indicating that a quantity is unchangeable on a display unit when a subject item of the quantity change request is an item prohibited to change the quantity.

(Supplementary Note 13)

13. A recording medium storing a program, the program causing a computer to perform a process comprising:
creating a list of items to be purchased based on the acquired item identification information;
receiving a quantity change request of an item included in the list of items to be purchased; and
displaying information indicating that a quantity is unchangeable on a display unit when a subject item of the quantity change request is an item prohibited to change the quantity.

While the invention of the present application has been described above with reference to the example embodiments, the invention of the present application is not limited to the above-described example embodiments. Various changes that can be understood by those skilled in the art can be made within the scope of the present disclosure in terms of the configuration and details of the present disclosure. That is, it goes without saying that the invention of the present application includes all disclosure including claims, various modifications and modifications that can be made by those skilled in the art in accordance with the technical idea. In addition, each disclosure of the above cited patent documents are incorporated into this document by citation.

This application claims priority on the basis of Japanese Patent Application No. 2019-191780 filed on Oct. 21, 2019 and incorporates all of its disclosures herein.

### DESCRIPTION OF SYMBOLS

1 POS server
2 Management server
3 Mobile terminal
5 Checkout Machine
56 Barcode reader
71 Checkout barcode
100 Purchase management system

What is claimed is:

1. A server apparatus comprising:
a memory storing instructions; and
one or more processors configured to execute the instructions to:
receive item identification information generated based on an item, from a terminal apparatus;
create a list of items to be purchased based on the received item identification information;
receive a quantity change request of an item included in the list of items to be purchased, from the terminal apparatus; and
transmit information indicating that a quantity is unchangeable to the terminal apparatus when a subject item of the quantity change request is an item prohibited to change the quantity.

2. The server apparatus according to claim 1, wherein
the item identification information of the item prohibited to change the quantity includes a specific information, and
the processor determines whether or not the item corresponds to the item prohibited to change the quality based on whether or not the specific information is included in the item identification information of the subject item of the quantity change request.

3. The server apparatus according to claim 1, further comprising a database configured to store items prohibited to change quantities in association with corresponding item identification information,
wherein the processor determines, by referring to the database, whether or not the subject item of the quantity change request is one of the items prohibited to change the quantities.

4. The server apparatus according to claim 1, wherein when the processor receives the item identification information of the same item prohibited to change the quantity multiple times, the determination unit transmits information indicating an error to the terminal apparatus.

5. The server apparatus according to claim 1, wherein when the processor receives the item identification information of the same item prohibited to change quantity, the processor transmits information indicating that the item has been already included in the list of items to be purchased.

6. The server apparatus according to claim 1, wherein the terminal apparatus is a mobile terminal, and the item identification information is information scanned by the mobile terminal from a code applied to each item.

7. The server apparatus according to claim 1, wherein the terminal apparatus is an apparatus that captures an image of the item, and generates the item identification information based on the captured image.

8. The server apparatus according to claim 1, wherein the item prohibited to change quantity corresponds to one of an item sold by weight and a discounted item according to a state.

9. A purchase management method performed by a server apparatus, the purchase management method comprising:
receiving item identification information generated based on an item, from a terminal apparatus;
creating a list of items to be purchased based on the received item identification information;
receiving a quantity change request of an item included in the list of items to be purchased, from the terminal apparatus; and
transmitting information indicating that a quantity is unchangeable to the terminal apparatus when a subject item of the quantity change request is an item prohibited to change the quantity.

10. (canceled)

11. An information processing system including a terminal apparatus and a server apparatus, the information processing system comprising:
one or more memories storing instructions; and
one or more processors configured to execute the instructions to:
acquire item identification information;
create a list of items to be purchased based on the acquired item identification information;
a quantity change unit configured to receive a quantity change request of an item included in the list of items to be purchased; and
display information indicating that a quantity is unchangeable on a display unit when a subject item of the quantity change request is an item prohibited to change the quantity.

12-13. (canceled)
